(19) United States
(12) Patent Application Publication
(10) Pub. No.: US 2012/0196608 A1
(43) Pub. Date: Aug. 2, 2012

(54) NETWORK ACCESS METHOD FOR M2M DEVICE AND BASE STATION USING THE SAME

(75) Inventors: Pang-An Ting, Taichung City (TW); Chia-Lung Tsai, Keelung City (TW); Ping-Heng Kuo, Pingtung County (TW); Wei-Chieh Huang, New Taipei City (TW)

(73) Assignee: INDUSTRIAL TECHNOLOGY RESEARCH INSTITUTE, Hsinchu (TW)

(21) Appl. No.: 13/308,521

(22) Filed: Nov. 30, 2011

Related U.S. Application Data
(60) Provisional application No. 61/438,126, filed on Jan. 31, 2011.

(51) Int. Cl. H04W 72/04; H04W 74/00

(52) U.S. Cl. 455/450; 455/455

(57) ABSTRACT

Network access methods for M2M device, M2M devices and base stations using the same methods are proposed. The proposed method allows M2M devices to perform random access process in the synchronous random access channel when the RTD information to the preferred base station is available. In another embodiment, the base station determines mobility type of a M2M device, determines a dedicated random access channel allocation for the M2M device according to the mobility type of the M2M device, and sends a paging message indicating the dedicated random access channel allocation.

### CROSS-REFERENCE TO RELATED APPLICATION

This application claims the priority benefits of U.S. provisional application Ser. No. 61/438,126, filed on Jan. 31, 2011. The entirety of the above-mentioned patent application is hereby incorporated by reference herein and made a part of this specification.

### TECHNICAL FIELD

The disclosure generally relates to a network access method for M2M device, a M2M device and a base station using the same method.

### BACKGROUND

Machine to Machine (M2M) communications (also called machine-type-communication, abbreviated as MTC) is a very distinct capability that enables the implementation of the “Internet of things”. It is defined as information exchange between a subscriber station (or a wireless communication device) and a server in the core network (through a base station) or just between subscriber stations, which may be carried out without any human interaction. Several industry reports have scoped out huge potential for this market. Given the huge potential, some novel broadband wireless access systems, such as 3GPP LTE and IEEE 802.16m, have started to develop enhancements for enabling M2M communications.

In some use case models of M2M communications, such as healthcare, secured access & surveillance, public safety, and remote maintenance & control, high priority access is necessary in order to communicate alarms, emergency situations or any other device states that require immediate attention. Besides, for battery-limited M2M devices, consuming extremely low operational power over long periods of time is required. Such M2M devices may be in idle mode at most time for power saving. Hence, prioritized ranging (or random access) is an essential function for idle M2M devices while they want to transmit delay-sensitive messages to the M2M server(s). On the other hand, in such urgent cases, the backbone wireless communication system should have ability to provide enough ranging capacity for those delay-sensitive applications even if it may be a rare case of mass ranging attempts for emergency occurring simultaneously.

According to current wireless communication standards, an idle mode of a wireless communication device may be only terminated through: the wireless communication device performing a network re-entry to the network; a paging controller in the wireless communication system detecting of the wireless communication device being unavailability through repeated, unanswered paging messages; expiration of the idle mode timer at the wireless communication device; entering another mode such as a deregistration with content retention (DCR) mode from the idle mode, and so forth. Further, the wireless communication device may terminate its idle mode at any time, and perform its network re-entry procedure with its preferred access base station.

In some cases when the wireless communication system or an M2M application server requires communication with the idle mode M2M device(s), paging mechanism may be triggered by the wireless communication system for the idle mode M2M device(s) performing the network re-entry procedure. Multiple groups of M2M devices may be grouped simultaneously, and thus while the M2M devices are performing network re-entry procedures, other wireless communication devices may also initiate random access (or ranging) for their respective voluntary transmission at the same time. This scenario may cause interruptions for the network re-entry of the M2M devices, which may be requested to provide emergency information. Therefore, it is a major concern to modify the conventional network access protocols so as to prevent foreseeable effects of network re-entry, in which a potentially large number of wireless communication devices are attempting to access the network simultaneously.

### SUMMARY

A network access method is introduced herein. According to an exemplary embodiment, the network access method is adapted to a M2M device, and includes following steps: performing a random access process through a first type channel with a base station when the round trip delay (RTD) information to the base station is not available; and performing the random access process through a second type channel with a base station when the RTD information to the base station is available.

A network access method is introduced herein. According to an exemplary embodiment, the network access method is adapted to a base station and includes following steps: receiving a ranging signal from a M2M device in a synchronous ranging channel; checking a ranging code in the ranging signal; determining that the ranging signal is a request for periodic ranging when the ranging code in the ranging signal is a periodic ranging code; and determining that the ranging signal is a network re-entry request when the ranging code in the ranging signal is a re-entry ranging code.

A M2M device is introduced herein. According to an exemplary embodiment, the M2M device includes a transceiver module and a communication protocol module. The transceiver module is configured for transmitting signal to and receiving signal from a base station. The communication protocol module is connected to the transceiver module, and configured for performing a network access process through a first type of random access channel with a base station when the round trip delay (RTD) information to the base station is not available, and performing the network access process through a second type channel with a base station when the RTD information to the base station is available.

A base station is introduced herein. According to an exemplary embodiment, the base station includes a transceiver module and a communication protocol module. The transceiver module is configured for transmitting signal to and receiving signal from at least a wireless communication device. The communication protocol module is connected to the transceiver module, and configured for receiving a ranging signal from a M2M in a synchronous ranging channel, checking a ranging code in the ranging signal, determining that the ranging signal is a request for periodic synchronization when the ranging code in the ranging signal is a periodic ranging code, and determining that the ranging signal is a network re-entry request when the ranging code in the ranging signal is a re-entry ranging code.

A network access method is introduced herein. According to an exemplary embodiment, the network access method is adapted to a base station, and includes following steps: determining mobility type of a M2M device; determining a dedicated channel allocation for the M2M device according to the mobility type of the M2M device; and sending a paging advertisement message indicating the dedicated channel allocation.

A network access method is introduced herein. According to an exemplary embodiment, the network access method is adapted to a base station, and includes following steps: performing a network access process with a base station; receiving a paging advertisement message; and performing ranging in a dedicated ranging channel allocated by the base station in the paging advertisement message.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a functional block diagram illustrating a base station according to an exemplary embodiment.

FIG. 2 is a functional block diagram illustrating a wireless communication device according to an exemplary embodiment.

FIG. 3 illustrates an OFDM symbol of a synchronized random access channel.

FIG. 4 illustrates an OFDM symbol of a non-synchronized random access channel.

FIG. 5 illustrates a network access process for a wireless communication device having non round trip delay information according to an exemplary embodiment.

FIG. 6 illustrates a network access process for a wireless communication device having round trip delay information according to an exemplary embodiment.

FIG. 7 is a flowchart illustrating a network access method according to an exemplary embodiment.

FIG. 8 is a flowchart illustrating a network access method according to an exemplary embodiment.

FIG. 9 is a flowchart illustrating a network access method according to an exemplary embodiment.

FIG. 10 is a flowchart illustrating a network access method according to an exemplary embodiment.

FIG. 11 illustrates a network access process for a wireless communication device according to an exemplary embodiment.

FIG. 12 illustrates another network access process for a wireless communication device according to an exemplary embodiment.

FIG. 13 illustrates another network access process for a wireless communication device according to an exemplary embodiment.

### DESCRIPTION OF THE EXEMPLARY EMBODIMENTS

Some embodiments of the present application will now be described more fully hereinafter with reference to the accompanying drawings, in which some, but not all embodiments of the application are shown. Indeed, various embodiments of the application may be embodied in many different forms and should not be construed as limited to the embodiments set forth herein; rather, these embodiments are provided so that this disclosure will satisfy applicable legal requirements. Like reference numerals refer to like elements throughout.

In the present disclosure, there are proposed functionalities of prioritized random access (also known as ranging) method to satisfy the delay requirements of most Machine-to-Machine applications (M2M applications, also called the MTC type applications). Therefore, the conventional random access protocols are modified so as to achieve prioritized random access with congestion detection and contention resolution mechanisms.

Throughout the disclosure, the wireless communication device could refer to an user equipment (UE), a mobile station, an advanced mobile stations, a wireless terminal communication device, a M2M device, a MTC device, and so forth. The wireless communication device can be, for example, a digital television, a digital set-top box, a personal computer, a notebook PC, a tablet PC, a netbook PC, a mobile phone, a smart phone, a water meter, a gas meter, an electricity meter, an emergency alarm device, a sensor device, a video camera, and so forth. Also, the base station (BS) could refer to an advanced base station (ABS), a node B, an enhanced node B (eNB), and so forth.

In the present disclosure, the term “downlink” (DL) refers to the RF signal transmission from a base station to a wireless communication device within the radio coverage of the base station; the term “uplink” (UL) refers to the RF signal transmission from a wireless communication device to its access base station. Also, the term “random access process” can also refer to the term “ranging” as specified in IEEE 802.16 standard.

The present disclosure proposes a network access method for wireless communication devices in wireless communication systems. It is assumed, in the present disclosure, that all ranging (random access) attempts can be classified into several priority levels in advance according to their respective priority or delay requirements. From other perspectives, wireless communication devices can be classified into different priority group according to their respective service requirements or delay requirements. The proposed network access method can guarantee that a high priority ranging (random access attempt) should be served earlier than a low priority ranging (random access attempt). In particular, the proposed network access method can be seen as a network re-entry method for the idle mode wireless communication devices, which intends to re-enter the wireless communication device. Also, the proposed network access method can be seen as ranging (random access) parameter assignment method for a base station, and the high priority ranging (random access attempt) can be guaranteed to be served earlier than the low priority ranging (random access attempt) through such ranging (random access) parameter assignment scheme.

The group paging can be used for M2M devices, and M2M group identifier (MGID) defined in IEEE 802.16p specification is included in a paging message instead of an individual device identifier to identify the group of M2M devices. Therefore, for the network re-entry procedure indicated by a group paging message that contains ranging (random access) configuration, M2M devices can select a ranging (random access) opportunity according to the ranging (random access) configuration. In the present disclosure, the ranging (random access) configuration can include a differentiated waiting offset time (before performing another ranging procedure) and a back-off window size (for the ranging procedure).

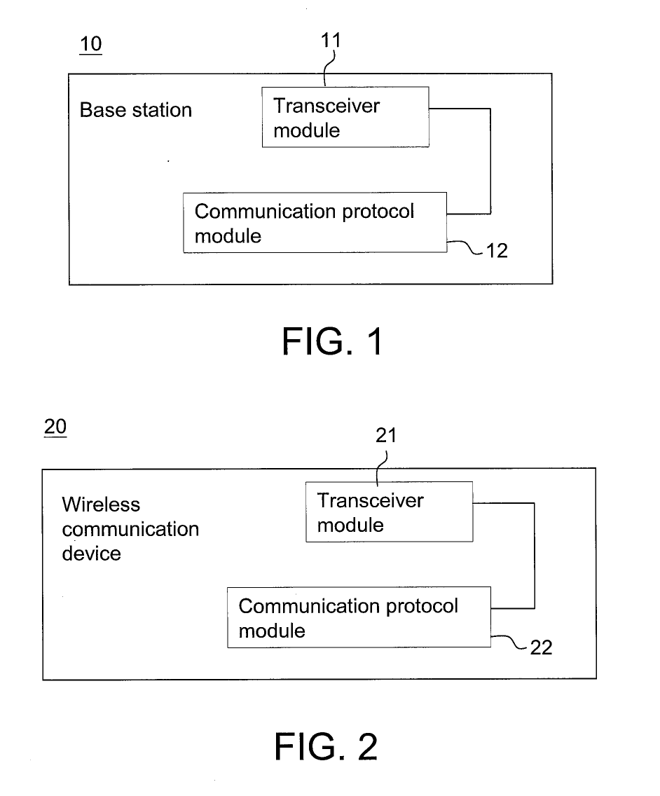

FIG. 1 is a functional block diagram illustrating a base station according to an exemplary embodiment. Referring to FIG. 1, the base station 10 includes a transceiver module 11 and a communication module 12. The transceiver module 11 is configured for transmitting signal to and receiving signal from one or more wireless communication devices within its radio service coverage. The communication protocol module 12 is connected to the transceiver module 11, and configured for assigning random access parameters to the wireless communication devices and processing network access requests from the wireless communication devices. In addition, the base station 10 can include other components (not illustrated) such as a processor module, a memory module, a fixed network module and an antenna module for connecting to other processing units in the wireless communication network as well as processing signals from one or more wireless communication devices within its radio service coverage.

FIG. 2 is a functional block diagram illustrating a wireless communication device according to an exemplary embodiment. Referring to FIG. 2, the wireless communication device 20 includes a transceiver module 21 and a communication protocol module 22. The transceiver module 21 is configured for transmitting signal to and receiving signal from a base station. The communication protocol module 22 is connected to the transceiver module 21, and configured for performing random back-off procedure and performing network access request to the base station. In addition, the wireless communication device 20 can include other components (not illustrated) such as a processor module, a memory module, and an antenna module for processing signals from a base station.

In the present disclosure, there is proposed a network access method through synchronous ranging channel (random access channel). In current cellular network systems, synchronization, including physical (PHY) layer synchronization and media access control (MAC) layer synchronization, shall be achieved before a wireless communication device is allowed to access the cellular network. For PHY synchronization, a wireless communication device may achieve timing synchronization, frequency synchronization, and power control via downlink synchronization channel and uplink synchronization channel. For MAC synchronization, system information negotiation and registration are accomplished via network access (or network entry) process.

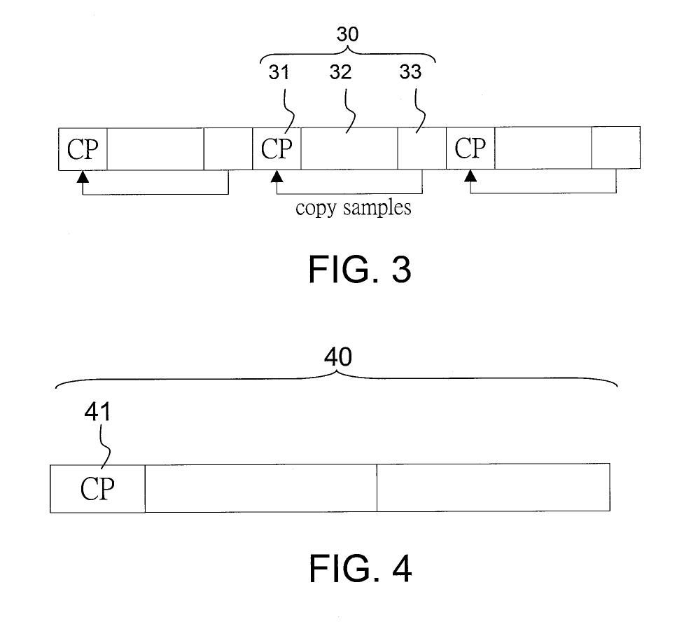

In general, uplink synchronization and network access are normally performed based on contention-based manner. The contention-based channel is usually called as random access channel (RACH) or ranging channel. Further, the random access channel may be further labeled as two classes: non-synchronous random access channel (NS-RACH) and synchronous ranging channel (S-RACH). In general, a S-RACH has an identical OFDM symbol period as data channel, as shown in FIG. 3. FIG. 3 illustrates an OFDM symbol of a synchronized random access channel. The OFDM symbol of the S-RACH has cyclic-prefix (CP) 31 and a data portion 32 over a duration 30, where the CP 31 is copying samples from the tail 33 of data portion 32. On the other hand, compared to S-RACH, NS-RACH generally requires longer cyclic-prefix (CP) length and longer period due to the timing uncertainty. FIG. 4 illustrates an OFDM symbol of a non-synchronized random access channel. The OFDM symbol of the NS-RACH has CP 41 and data portions (not labeled) over a duration 40.

Although the wireless communication devices may synchronize to downlink synchronization channel, it cannot determine its distance from the base station. Thus, timing uncertainty caused by round trip delay (RTD) exists in random access transmission. Accordingly, when a wireless communication device performs network access with a preferred base station, only the NS-RACH is provided in the current network access method. In addition, the S-RACH is designed for the wireless communication devices that have accessed network to maintain the synchronization with the base station. In general, the S-RACH has following effects over the NS-RACH: lower latency; lower power consumption; better performance; lower computational complexity; and higher the ranging (random access) channel capacity.

In the present exemplary embodiment, there is provided a random access method for wireless communication devices performing the network access. The wireless communication devices may perform the network access via S-RACH only when they have the knowledge about its RTD to the preferred base station. The RTD information may be obtained by using various schemes. For example, the base station broadcasts the information of its location to wireless communication devices within its radio service coverage. Meanwhile, a wireless communication device may obtain its location by global positioning system (GPS). Thus, the corresponding RTD can be calculated. Another example, when the wireless communication device has communicated with the base station previously, it may store the corresponding RTD information.

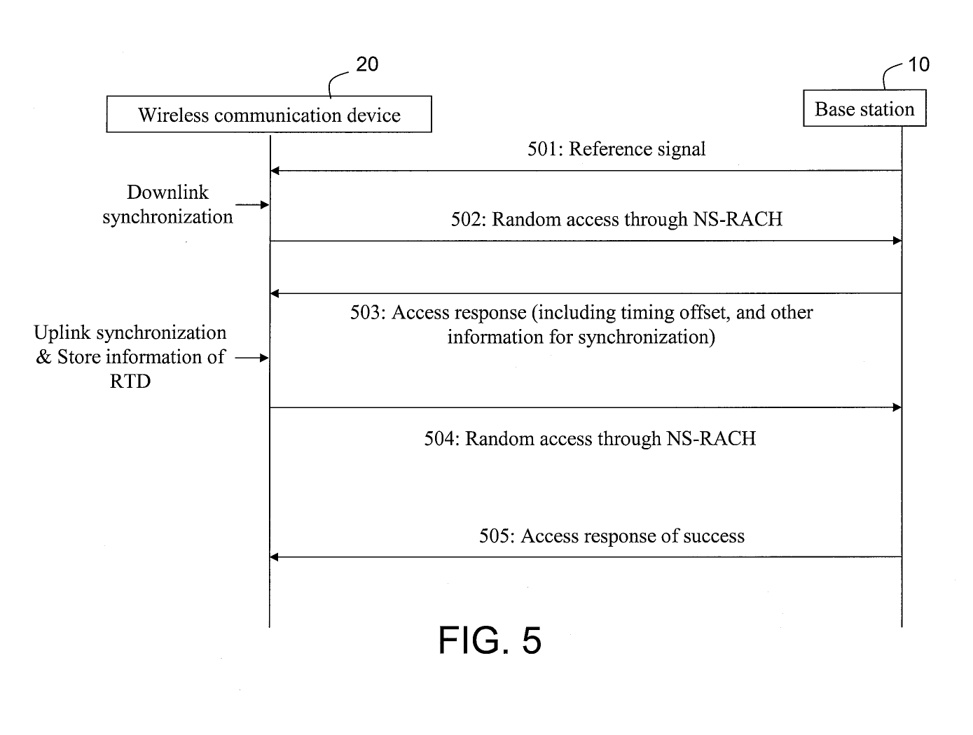

The illustration and flowchart of the exemplary embodiment are depicted in FIGS. 5-7 respectively. For example, at the first time of network access (i.e., the initial network access), a fixed wireless communication device shall access network through NS-RACH since it does not have the information of RTD. During the initial network access, the fixed wireless communication device can obtain the information of RTD. Since RTD will be a constant value for fixed wireless communication devices, the fixed wireless communication device can store the information of RTD for the network access process afterwards. For a fixed wireless communication device having the information of RTD, the fixed wireless communication device is able to achieve uplink timing synchronization with the preferred base station by using downlink channel and the information of RTD. As a result, such fixed wireless communication device is allowed to perform the network access process through the S-RACH. Furthermore, it is noted that the aforementioned concept can be easily extended to a mobile wireless communication device when it knows that it does not change the location.

For another example, the wireless communication device may obtain the location information of the preferred base station from broadcast channel. Further, the wireless communication device may obtain its own location information with the assistance of GPS, and the wireless communication device can thus calculate the corresponding RTD to the preferred based station. Therefore, for a wireless communication device having the information of RTD, the wireless communication device is able to achieve the uplink timing synchronization with base station by using downlink channel and the information of RTD. As a result, the wireless communication device is allowed to perform the network access process through the S-RACH.

FIG. 5 illustrates a network access process for a wireless communication device having no round trip delay information according to the present exemplary embodiment. Referring to FIG. 5, the network access process initiates from step 501. The base station 10 transmits reference signal to all wireless communication devices within its radio service coverage (step 501); the wireless communication device 20 performs its initial random access process through the NS-RACH since the wireless communication device 20 does not have its RTD information to the base station 10 (step 502); When the base station 10 determines that the uplink synchronization quality is unacceptable, the base station 10 replies an access response (including timing offset and other information for synchronization) (step 503); the wireless communication device 20 performs its random access process again through the NS-RACH (step 504); When the base station 10 determines the uplink synchronization is acceptable, the base station 10 replies an access response of success (step 505). The wireless communication device 20 can perform downlink synchronization with the preferred base station after the step 501, and the wireless communication device 20 can perform uplink synchronization with the preferred base station and storing information of RTD in the wireless communication device 20 after the step 503.

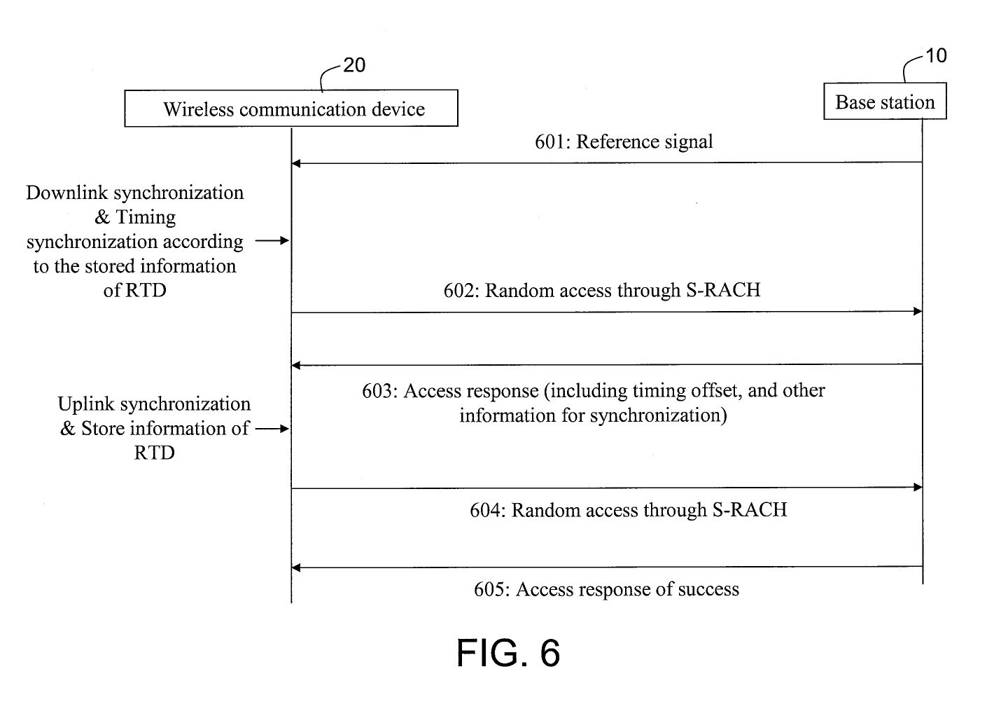

FIG. 6 illustrates a network access process for a wireless communication device having round trip delay information according to an exemplary embodiment. Referring to FIG. 6, it is presumed that the wireless communication device 20 has previously obtained RTD information to the preferred base station and the stored information of RTD, and the network access process initiates from step 601. The base station 10 transmits reference signal to all wireless communication devices within its radio service coverage (step 601); the wireless communication device 20 performs its random access process through the S-RACH since the wireless communication device 20 has its RTD information to the base station 10 (step 602); When the base station 10 determines that the uplink synchronization quality is unacceptable, the base station 10 replies an access response (including timing offset and other information for synchronization) (step 603); the wireless communication device 20 performs its random access process again through the S-RACH (step 604); When the base station 10 determines the uplink synchronization is acceptable, the base station 11 replies an access response of success (step 605). The wireless communication device 20 can perform downlink synchronization and uplink timing synchronization with the preferred base station according to the stored information of RTD after the step 601, and, if necessary, the wireless communication device 20 can perform uplink synchronization with the preferred base station and update information of RTD in the wireless communication device 20 after the step 603.

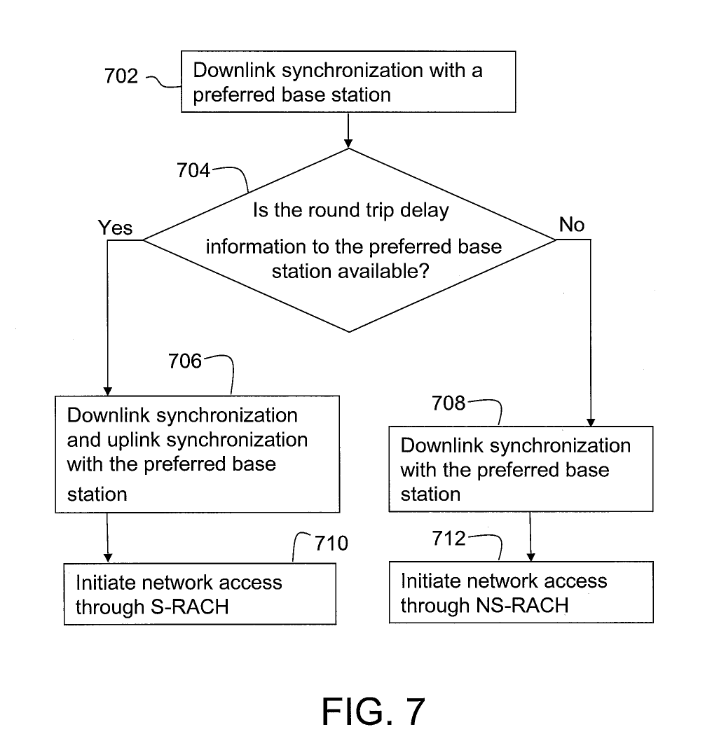

FIG. 7 is a flowchart illustrating a network access method according to an exemplary embodiment. Referring to FIG. 7, the network access method is adapted for a wireless communication device, particularly, a fixed wireless communication device, and initiates from a step 702. In step 702, the wireless communication device performs its downlink synchronization with a preferred base station. In step 704, the wireless communication device determines whether the round trip delay (RTD) information to the preferred base station is available. When the determination result is Yes in the step 704, step 706 is executed after the step 704; when the determination result is No in the step 704, step 708 is executed after the step 704. In the step 706, the wireless communication device performs downlink synchronization and uplink timing synchronization with the preferred base station since the RTD information to the preferred base station is available. In step 710, the wireless communication device initiates network access through the S-RACH since the uplink timing synchronization is achieved. On the other hand, in the step 708, the wireless communication device only performs downlink synchronization with the preferred base station since the RTD information is not available. Subsequently, in the step 712, the wireless communication device initiates network access through the NS-RACH since the uplink timing synchronization is not accomplished.

In the conventional network access method, the network access is generally performed via non-synchronous random access channel due to the timing uncertainty in uplink transmission. In the disclosure, it is proposed a network access method that allows the wireless communication devices having the information of RTD to the preferred base station to initiate network access through synchronous random access channel. When the S-RACH may contain different types of ranging codes, the base station should be able to distinguish different ranging codes in order to determine the purpose of connected wireless communication devices.

There is provided an exemplary network access method investigated in 802.16m. In the current 802.16m specification, the contention-based channel for network access is termed as ranging channel. The ranging channel is further labeled as two classes: non-synchronous ranging channel (NS-RCH) and synchronous ranging channel (S-RCH). Moreover, the NS-RCH is used for initial ranging and handover ranging. The S-RCH is used for periodic ranging. It is proposed that the fixed M2M devices, e.g., smart meters, are allowed to perform network re-entry from an idle mode through the S-RCH. Further, a base station shall have the ability to distinguish the purpose of devices connected through the S-RCH. Therefore, the “periodic ranging code group” and “re-entry ranging code group” should be well defined.

When the base station receives a ranging signal with a ranging code selected from the “periodic ranging code group” in the S-RCH, the base station determines such ranging signal as a request for periodic ranging, or equivalently periodic synchronization. On the other hand, when the base station receives a ranging signal with a ranging code selected from the “re-entry ranging code group” in the S-RCH, the base station determines such ranging signal as a network re-entry request from one of the fixed M2M devices.

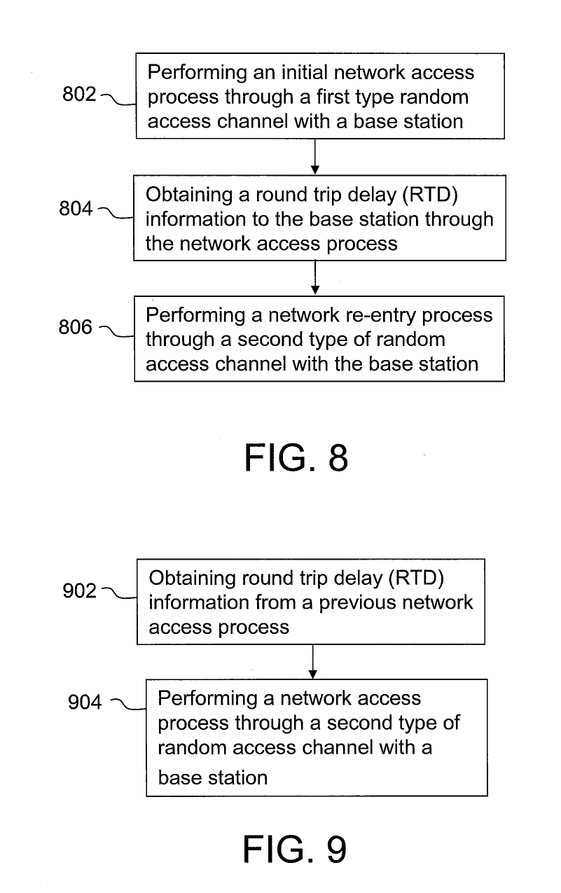

FIG. 8 is a flowchart illustrating a network access method according to an exemplary embodiment. Referring to FIG. 8, the network access method is adapted to a fixed wireless communication device, and initiates from step 802, in which the communication protocol module 22 of the wireless communication device 20 performs an initial network access process (or an initial random access process) through a first type random access channel with a base station. In step 804, the communication protocol module 22 obtains round trip delay (RTD) information to the base station through the network access process. In step 806, the communication protocol module 22 performs a network re-entry process (or a random access process) through a second type random access channel with the base station when the RTD information is available. In the present embodiment, the first type random access channel is a non-synchronous random access channel, and the second type random access channel is a synchronous random access channel. Alternatively, in other embodiments, the first type random access channel has a longer cyclic-prefix length than that of the data channel, and the second type random access channel has an identical cyclic-prefix length as that of the data channel. However, in another embodiment, the first type random access channel has a longer OFDM symbol period than that of the data channel, and the second type random access channel has an identical OFDM symbol period as that of the data channel. In addition, the first type random access channel can be NS-RCH, and the second type random access channel can be S-RCH.

FIG. 9 is a flowchart illustrating a network access method according to an exemplary embodiment. Referring to FIG. 9, the network access method is adapted to a wireless communication device and initiates from step 902, in which the communication protocol module 22 of the wireless communication device 20 obtains round trip delay (RTD) information from a previous network access process. In step 904, the communication protocol module 22 performs a network access process with a base station.

To be illustrated more clearly, in the step 904, the communication protocol module 22 performs a network access process through a second type random access channel with a base station when the round trip delay (RTD) information to the base station is available, where the second type random access channel has an identical cyclic-prefix length as that of the data channel. Alternatively, when the round trip delay (RTD) information to the base station is not available, the communication protocol module 22 performs the network access process through a first type random access channel with the base station, where the first type random access channel has a longer cyclic-prefix length than that of the data channel, or the first type random access channel has a longer OFDM symbol period than that of the data channel.

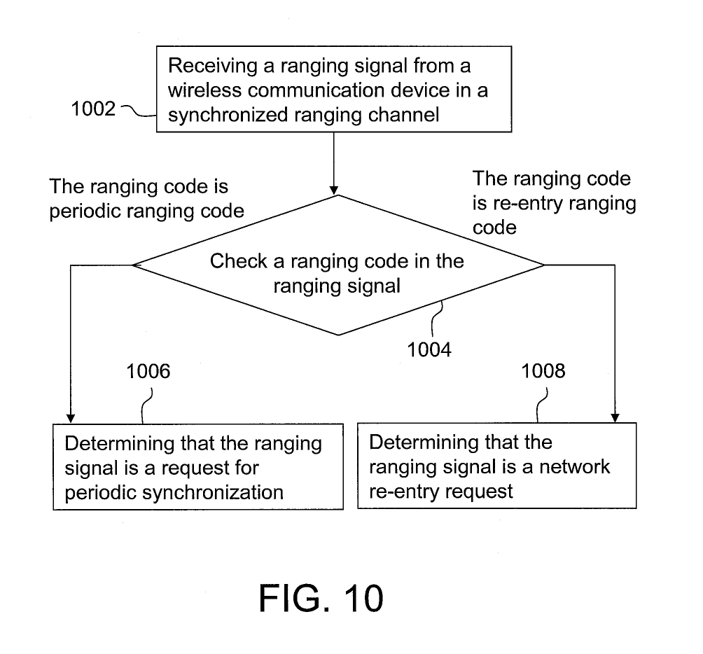

FIG. 10 is a flowchart illustrating a network access method according to an exemplary embodiment. Referring to FIG. 10, the network access method is adapted to a base station, and initiates from step 1002, in which the communication protocol module 12 of the base station 10 receives a ranging signal from a wireless communication device in a synchronous ranging channel. In step 1004, the communication protocol module 12 checks a ranging code in the ranging signal. When the ranging code of the ranging signal is a periodic ranging code, step 1006 is executed after the step 1004; otherwise, step 1008 is executed after the step 1004. In the step 1006, the communication protocol module 22 determines that the ranging signal is a request for periodic synchronization. In the step 1008, the communication protocol module 12 determines that the ranging signal is a network re-entry request. Also, the aforementioned ranging signal can be referred to random access signal in the present disclosure.

Another example, based on the mobility and traffic characteristics of the M2M device, the BS can select the proper network re-entry type for M2M device based on Table I, and the BS shall inform the M2M device of the network re-entry type in AAI-PAG-ADV message.

TABLE I
Scheme selection of network re-entry for M2M

| Network | | |
|---|---|---|
| re-entry type | Network re-entry scheme | Note |
| 0 | Dedicated channel allocation for | Fixed M2M, known |
| | AAI-RNG-REQ, A-MAP IE | traffic pattern, UL |
| | offset for AAI-RNG-REQ is | synchronization not |
| | indicated in AAI-PAG-ADV | required |
| 1 | Dedicated ranging channel | Fixed M2M, UL |
| | allocation for M2M group, | synchronization |
| | S-RCH used for ranging | required |
| 2 | Dedicated ranging channel | Mobile M2M, known |
| | allocation for M2M group, | traffic pattern |
| | NS-RCH used for ranging | |

If the network re-entry type is set to “0”, the M2M device doesn't need to send CDMA code for ranging but sends RNG-REQ message with the channel allocation in “Dedicated channel allocation” in AAI-PAG-ADV message.

If the network re-entry type is set to “1”, the ABS shall allocate the dedicated ranging channel for M2M device in AAI-PAG-ADV message, the dedicated S-RCH allocation is used for ranging.

If the network re-entry type is set to “2”, the ABS shall allocate the dedicated ranging channel for M2M device in AAI-PAG-ADV message, the dedicated NS-RCH allocation is used for ranging.

Table I is illustrated more clearly as the following. A M2M device can select network re-entry scheme for M2M application according to the Table I. For example, when the network re-entry type is set to “0”, the M2M device can know a dedicated channel allocation for a ranging request (e.g., AAI-RNG-REQ) to the base station, and required information (e.g., A-MAP IE) for the ranging request (e.g., AAI-RNG-REQ) is indicated in a paging advertisement message (e.g., AAI-PAG-ADV). In addition, the network re-entry type “0” is suitable for fixed M2M devices with known traffic pattern, and uplink synchronization is not required for the network re-entry type “0”. Therefore, when the M2M device is a fixed M2M device, the M2M device can know the dedicated random access channel allocated by the base station for the M2M device from the paging advertisement message, and the M2M device can also know that the dedicated random access channel is a dedicated synchronous ranging channel (S-RCH), and the S-RCH allocation is used for ranging.

On the other hand, when the M2M device is a mobile M2M device, the M2M device can know the dedicated random access channel allocated by the base station for the M2M device from the paging advertisement message, and the M2M device can also know that the dedicated random access channel is a dedicated non-synchronous ranging channel (NS-RCH), and the NS-RCH allocation is used for ranging.

For another example, when the network re-entry type is set to “1”, the M2M device can know a dedicated channel allocation from the base station for a M2M group, and synchronized random access channel (e.g., S-RCH) is used for the ranging request (e.g., AAI-RNG-REQ). The dedicated channel allocation is indicated in a paging advertisement message (e.g., AAI-PAG-ADV). In addition, the network re-entry type “1” is suitable for Fixed M2M device, and the uplink synchronization is required for the network re-entry type “1”.

For another example, when the network re-entry type is set to “2”, the M2M device can know a dedicated channel allocation from the base station for a M2M group, and non-synchronized random access channel (e.g., NS-RCH) is used for the ranging request (e.g., AAI-RNG-REQ). The dedicated channel allocation is indicated in a paging advertisement message (e.g., AAI-PAG-ADV). In addition, the network re-entry type “2” is suitable for Mobile M2M device with known traffic pattern.

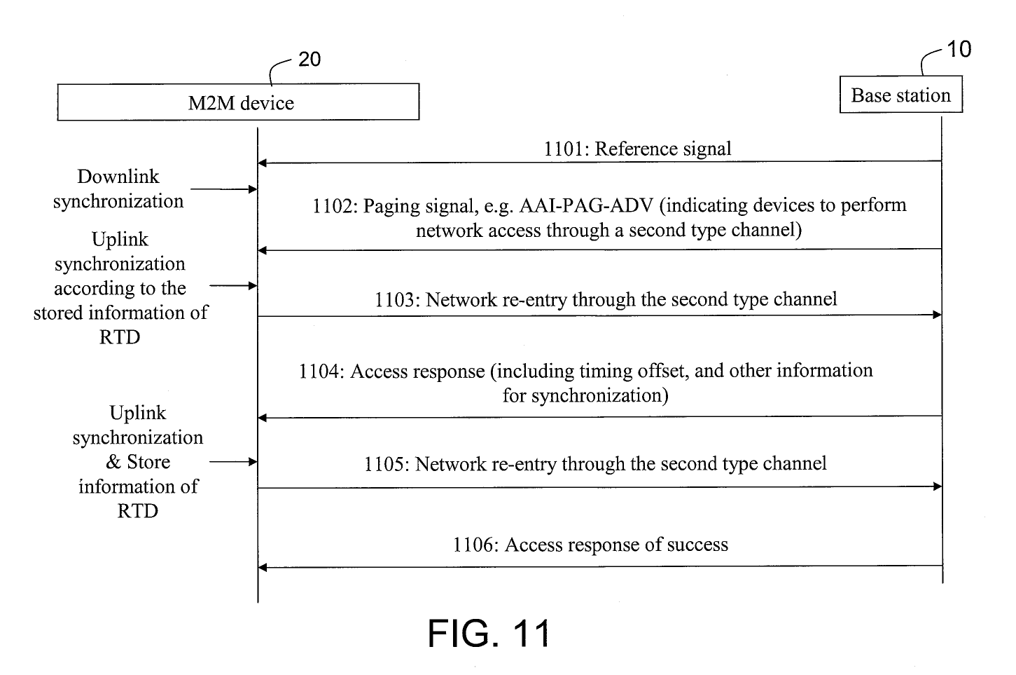

FIG. 11 illustrates a network access process for a wireless communication device according to an exemplary embodiment. FIG. 11 illustrates a more detailed technical disclosure of the embodiment illustrated in FIG. 6. Referring to FIG. 11, it is presumed that a M2M device 20 has previously obtained RTD information to the preferred base station through an initial network access process performed in a first type channel (e.g., the NS-RACH), and stored the information of RTD. The proposed network access process initiates from step 1101. In the step 1101, the base station 10 transmits reference signal to all M2M devices (including the M2M device 20) within its radio service coverage. In step 1102, the base station 10 transmits a paging signal, for example, a paging advertisement message such as AAI-PAG-ADV, to indicate M2M devices within its radio service coverage to perform network access through a second type channel (e.g., the S-RACH).

In step 1103, the M2M device 20 performs a network re-entry through the second type channel since the M2M device 20 has its RTD information to the base station 10. In step 1104, when the base station 10 determines that the uplink synchronization quality is unacceptable, the base station 10 replies an access response (including timing offset and other information for synchronization). In step 1105, the wireless communication device 20 performs the network re-entry again through the second type channel. In step 1106, when the base station 10 determines the uplink synchronization is acceptable, the base station 11 replies an access response of success.

The M2M device 20 can perform downlink synchronization with the base station 20 after step 1101. The M2M device 20 can perform uplink synchronization with the base station 20 according to the stored information of RTD after the step 1102, and, if necessary, the M2M device 20 can perform uplink synchronization with the base station 20 and store information of RTD in the M2M device 20 after the step 1104.

Furthermore, in the present embodiment, the M2M device 20 can perform ranging in a dedicated ranging channel allocated by the base station 10 in the paging advertisement message, where the ranging is the random access process, and the dedicated ranging channel is the second type channel. For example, when the M2M device 20 is a fixed M2M device, the dedicated ranging channel for the M2M device 20 is a dedicated synchronous ranging channel (S-RCH), and the S-RCH allocation is used for ranging. For another example, when the M2M device 20 is a mobile M2M device, the dedicated ranging channel for the M2M device 20 is a dedicated non-synchronous ranging channel (NS-RCH), and the NS-RCH allocation is used for ranging.

Also, in the present embodiment from another perspective, when the random access process is a network re-entry process and the network re-entry type is set to “0”, the M2M device 20 sends a ranging request message, such as RNG-REQ request message, with a channel allocation in “dedicated ranging channel” in AAI-PAG-ADV message. In other words, when the random access process is a network re-entry process and the network re-entry type is set to “0”, the M2M device 20 sends a random access request (to the base station) with a channel allocation in a dedicated random access channel indicated in a paging advertisement message received from the base station.

When the random access process is a network re-entry process and the network re-entry type is set to “1”, the M2M device 20 sends a ranging request to the base station 20 in a dedicated S-RCH channel allocated in AAI-PAG-ADV message. In other words, the M2M device 20 sends a random access request to the base station in a dedicated S-RCH channel allocated in a paging advertisement message received from the base station 20.

When the random access process is a network re-entry process and the network re-entry type is set to “2”, the M2M device 20 sends a ranging request to the base station in a dedicated NS-RCH channel allocated in AAI-PAG-ADV message. In other words, the M2M device 20 sends a random access request to the base station in a dedicated NS-RCH channel allocated in a paging advertisement message received from the base station 20.

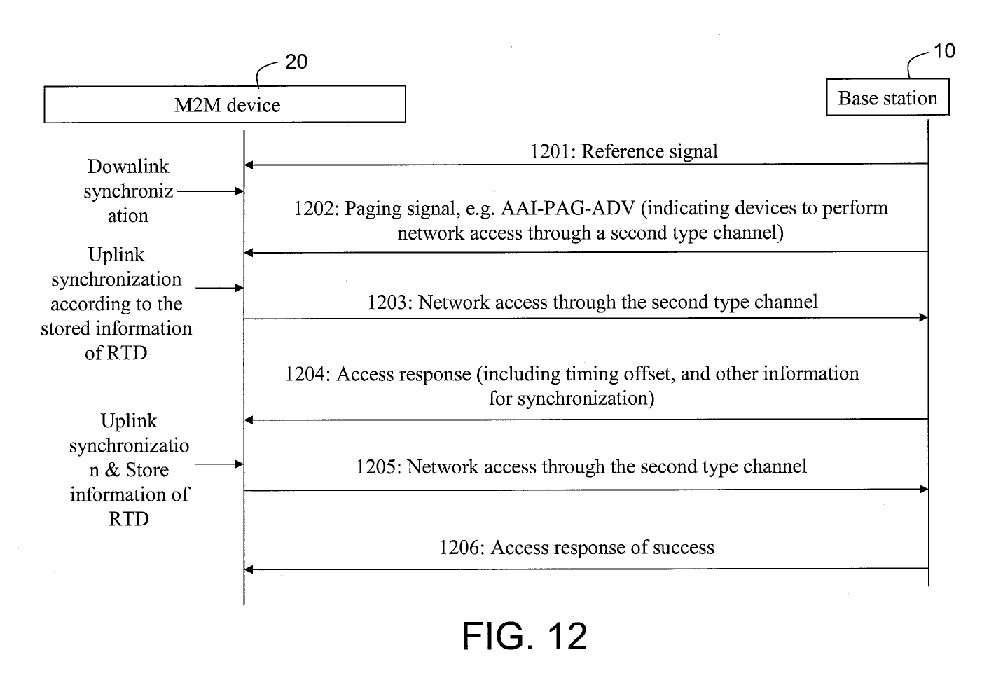

FIG. 12 illustrates another network access process for a wireless communication device according to an exemplary embodiment. FIG. 12 illustrates a more detailed technical disclosure of the embodiment illustrated in FIG. 6. Referring to FIG. 12, it is presumed that a M2M device has previously obtained RTD information to the preferred base station through an initial network access process performed in a first type channel (e.g., the NS-RACH), and stored the information of RTD. The proposed network access process initiates from step 1201. In the step 1201, the base station 10 transmits reference signal to all M2M devices (including the M2M device 20) within its radio service coverage. In step 1202, the base station 10 transmits a paging signal, for example, AAI-PAG-ADV, to indicate M2M devices within its radio service coverage to perform network access through a second type channel (e.g., the S-RACH).

In step 1203, the M2M device 20 performs a network access through the second type channel since the M2M device 20 has its RTD information to the base station 10. In step 1204, when the base station 10 determines that the uplink synchronization quality is unacceptable, the base station 10 replies an access response (including timing offset and other information for synchronization). In step 1205, when the wireless communication device 20 performs the network access again through the second type channel. In step 1206, when the base station 10 determines the uplink synchronization is acceptable, the base station 11 replies an access response of success.

The M2M device 20 can perform downlink synchronization with the base station 20 after step 1201. The M2M device 20 can perform uplink synchronization with the base station 20 according to the stored information of RTD after the step 1202, and, if necessary, the M2M device 20 can perform uplink synchronization with the base station 20 and store information of RTD in the M2M device 20 after the step 1204.

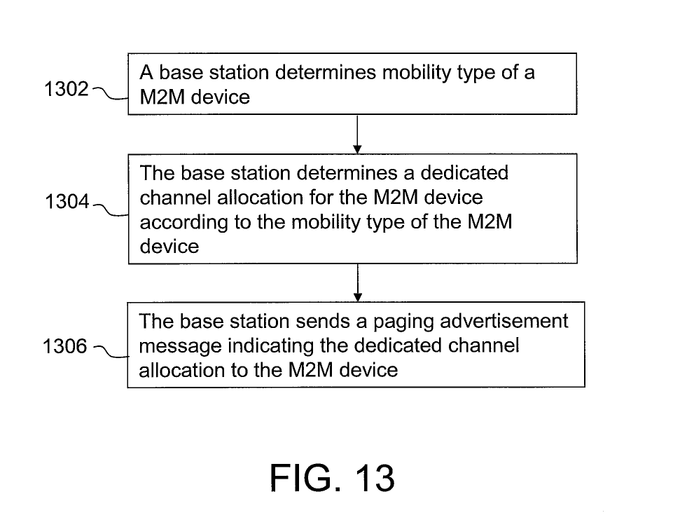

FIG. 13 illustrates another network access process for a wireless communication device according to an exemplary embodiment. Referring to FIG. 13, the network access process is adapted to a base station to allocate random access channel for a M2M device. The proposed network access process initiates from step 1302, in which a base station 10 determines mobility type of a M2M device 20. In step 1304, the base station 10 further determines a dedicated channel allocation for the M2M device according to the mobility type of the M2M device 20. In step 1306, the base station 10 sends a paging advertisement message indicating the dedicated ranging channel allocation to the M2M device.

In the present embodiment, when the M2M device is determined as a fixed M2M device, the dedicated ranging channel allocation for the M2M device is a dedicated synchronous ranging channel (S-RCH), and the dedicated S-RCH allocation is used for ranging. Otherwise, when the M2M device is determined as a mobile M2M device, the dedicated ranging channel allocation for the M2M device is a dedicated non-synchronous ranging channel (NS-RCH), and the dedicated NS-RCH allocation is used for ranging.

In summary, according to the exemplary embodiments of the disclosure, network access methods for M2M device, M2M devices and base stations using the same methods are proposed. In one embodiment, the proposed method allows the fixed M2M devices to perform network re-entry in the synchronized random access channel when the RTD information to the preferred base station is available. In another embodiment, the mobile M2M devices perform network re-entry in the non-synchronized random access channel. In other embodiments, a M2M device sends ranging request message, with the channel allocation indicated in paging advertisement, to the base station depending upon network re-entry type of the M2M device.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A network access method, adapted to a M2M device, comprising:
performing a random access process through a first type channel with a base station when the round trip delay (RTD) information to the base station is not available; and
performing the random access process through a second type channel with a base station when the RTD information to the base station is available.

2. The network access method according to claim 1, wherein the first type channel is a non-synchronous random access channel, and the second type channel is a synchronous random access channel.

3. The network access method according to claim 1, wherein the first type channel has a longer cyclic-prefix length than that of the data channel, and the second type channel has an identical cyclic-prefix length as that of the data channel.

4. The network access method according to claim 1, wherein the first type channel has a longer OFDM symbol period than that of the data channel, and the second type channel has an identical OFDM symbol period as that of the data channel.

5. The network access method according to claim 1, wherein before performing the network access process through the second type channel with the base station, the method further comprises:
obtaining the RTD information from a previous network access process.

6. The network access method according to claim 1, wherein after the step of performing the random access process through the first type channel, the network access method further comprises:
receiving a paging advertisement message from the base station; and
performing random access process in a dedicated random access channel allocated by the base station in the paging advertisement message, wherein the dedicated random access channel is the second type channel.

7. The network access method according to claim 6, wherein when the M2M device is a fixed M2M device, the dedicated random access channel for the M2M device is a dedicated synchronous ranging channel (S-RCH), and the S-RCH is used for ranging.

8. The network access method according to claim 6, wherein when the M2M device is a mobile M2M device, the dedicated random access channel for the M2M device is a dedicated non-synchronous ranging channel (NS-RCH), and the NS-RCH is used for ranging.

9. The network access method according to claim 6, wherein when the random access process is a network re-entry process, and the network re-entry type is set to “0”, the network access method further comprises:
sending a random access request with a channel allocation in a dedicated random access channel indicated in the paging advertisement message.

10. The network access method according to claim 6, wherein when the random access process is a network re-entry process, and the network re-entry type is set to “1”, the network access method further comprises:
sending a random access request to the base station in a dedicated S-RCH channel allocated in the paging advertisement message.

11. The network access method according to claim 6, wherein when the random access process is a network re-entry process, and the network re-entry type is set to “2”, the network access method further comprises:
sending a random access request to the base station in a dedicated NS-RCH channel allocated in the paging advertisement message.

12. The network access method according to claim 1, wherein when the M2M device is a fixed M2M device, the network access method further comprises:
performing an initial random access process through the first type channel with the base station;
obtaining the RTD information to the base station through the initial random access process; and
performing the random access process through the second type channel with the base station when the RTD information is available.

13. A network access method, adapted to a base station, comprising:
receiving a ranging signal from a M2M device in a synchronous ranging channel;
checking a ranging code in the ranging signal;
determining that the ranging signal is a request for periodic ranging when the ranging code in the ranging signal is a periodic ranging code; and
determining that the ranging signal is a network re-entry request when the ranging code in the ranging signal is a re-entry ranging code.

14. A M2M device, comprising:
a transceiver module, configured for transmitting signal to and receiving signal from a base station; and
a communication protocol module, connected to the transceiver module, configured for performing a network access process through a first type channel with a base station when the round trip delay (RTD) information to the base station is not available, and performing the network access process through a second type channel with a base station when the RTD information to the base station is available.

15. The M2M device according to claim 14, wherein the first type for channel is a non-synchronous random access channel, and the second type channel is a synchronous random access channel.

16. The M2M device according to claim 14, wherein the first type channel has a longer cyclic-prefix length as that of the data channel, and the second type channel has an identical cyclic-prefix length as that of the data channel.

17. The M2M device according to claim 14, wherein the first type channel has a longer OFDM symbol period than that of the data channel, and the second type channel has an identical OFDM symbol period as that of the data channel.

18. The M2M device according to claim 14, wherein the communication protocol module obtains the RTD information from a previous network access process.

19. The M2M device according to claim 14, wherein when the M2M device is a fixed M2M device, the communication protocol module is configured for performing an initial random access process through the first type channel with the base station; obtaining the RTD information through the initial random access process; and performing the random access process through a second type channel with the base station when the RTD information is available.

20. A base station, comprising:
a transceiver module, configured for transmitting signal to and receiving signal from at least a M2M device; and
a communication protocol module, connected to the transceiver module, configured for receiving a ranging signal from a M2M in a synchronous ranging channel, checking a ranging code in the ranging signal, determining that the ranging signal is a request for periodic synchronization when the ranging code in the ranging signal is a periodic ranging code, and determining that the ranging signal is a network re-entry request when the ranging code in the ranging signal is a re-entry ranging code.

21. A network access method, adapted to a base station, comprising:
determining mobility type of a M2M device;
determining a dedicated ranging channel allocation for the M2M device according to the mobility type of the M2M device; and
sending a paging advertisement message indicating the dedicated ranging channel allocation.

22. The network access method according to claim 21, wherein when the M2M device is determined as a fixed M2M device, the dedicated ranging channel allocation for the M2M device is a synchronous ranging channel (S-RCH), and the dedicated S-RCH allocation is used for ranging.

23. The network access method according to claim 21, wherein when the M2M device is determined as a mobile M2M device, the dedicated ranging channel allocation for the M2M device is a non-synchronous ranging channel (NS-RCH), and the dedicated NS-RCH allocation is used for ranging.

24. A network access method, adapted to a M2M device, comprising:
performing a network access process with a base station;
receiving a paging advertisement message; and
performing ranging in a dedicated ranging channel allocated by the base station in the paging advertisement message.

25. The network access method according to claim 24, wherein when the M2M device is a fixed M2M device, the dedicated ranging channel allocated for the M2M device is a synchronous ranging channel (S-RCH), and the S-RCH allocation is used for ranging.

26. The network access method according to claim 24, wherein when the M2M device is a mobile M2M device, the dedicated ranging channel allocated for the M2M device is a non-synchronous ranging channel (NS-RCH), and the NS-RCH allocation is used for ranging.
